(19) United States
(12) Patent Application Publication
(10) Pub. No.: US 2020/0317349 A1
(43) Pub. Date: Oct. 8, 2020

(54) AIRCRAFT DEVICE AND METHOD FOR PRODUCING AN AIRCRAFT DEVICE

(71) Applicant: E.I.S. Aircraft Products and Services GmbH, Euskirchen (DE)

(72) Inventors: Sven Ulrich ACHILLES, Michelfeld (DE); Gerold Karl HUPPERICH, Dahlem (DE)

(21) Appl. No.: 16/498,591

(22) PCT Filed: Mar. 29, 2018
(86) PCT No.: PCT/EP2018/000139

§ 371 Date: Sep. 27, 2019

(30) Foreign Application Priority Data
Mar. 30, 2017 (DE) 10 2017 003 121.5

(51) Int. Cl. B64D 11/06; B29C 45/14; B29C 45/00

(52) U.S. Cl. CPC B64D 11/0649; B29L 2031/3076; B29C 45/0005; B29C 45/14467

(57) ABSTRACT

An aircraft device, in particular an aircraft seat device, comprises at least one load-bearing constructional unit, which in at least one outer subregion of the constructional unit consists of a plastic reinforced with reinforcing fibers wherein the reinforcing fibers are distributed at least substantially homogeneously over the entire outer subregion and/or the outer subregion has essential load-bearing properties.

### PRIOR ART

The invention is based on an aircraft device according to the preamble of claim 1 and a method for producing an aircraft device as claimed in claim 17.

The prior art discloses aircraft seats which comprise at least one load-bearing constructional unit consisting at least partially of a plastic reinforced with reinforcing fibers. Used for producing the load-bearing constructional unit in this case are sheets and/or mats of a glass fiber fabric and/or carbon fiber fabric, known as “prepregs”, which are overmolded with an unreinforced plastic, which results in an elaborate and complicated production process.

The object of the invention is in particular that of providing a device of the type in question that has improved properties with regard to an efficiency. The object is achieved by the characterizing features of claim 1 and the feature of claim 17, while advantageous refinements and developments of the invention can be taken from the subclaims.

### Advantages of the Invention

The invention is based on an aircraft device, in particular an aircraft seat device, with at least one load-bearing constructional unit, which in at least one outer subregion of the constructional unit consists of a plastic reinforced with reinforcing fibers.

It is proposed that the reinforcing fibers are distributed at least substantially homogeneously over the entire outer subregion. This refinement allows an aircraft device that has improved properties with regard to an efficiency, in particular a production efficiency, a component efficiency, a weight efficiency and/or a cost efficiency, to be provided. Moreover, a stability can be advantageously increased and/or a weight of the aircraft device can be advantageously reduced. In addition, a flexibility can be advantageously improved, in particular a design flexibility.

An “aircraft device” is to be understood in this context as meaning in particular at least a part, in particular a subassembly, of an aircraft, in particular of an aircraft seat. Advantageously, the aircraft device is in this case configured, in particular specifically configured, for use in an aircraft, advantageously a cabin of the aircraft. “Configured” is in particular to be understood as meaning specifically designed and/or equipped. That an object is configured for a specific function is to be understood as meaning in particular that the object fulfills and/or performs this specific function in at least one application state and/or operating state. Furthermore, a “load-bearing constructional unit” is to be understood as meaning in particular a unit, advantageously a cabin component of the aircraft, which is configured to withstand customary and/or typical forces and/or pressures acting on the load-bearing constructional unit, in particular without thereby being deformed and/or destroyed. In particular, the load-bearing constructional unit can in this case absorb, in particular at least for a time and advantageously for a sustained time, a stress and/or a pressure of at least 20 MPa, preferably of at least 40 MPa, advantageously of at least 60 MPa, particularly preferably of at least 100 MPa, and particularly advantageously of at least 150 MPa, in particular without thereby being deformed and/or destroyed. Preferably, the load-bearing constructional unit is configured for absorbing a weight of at least one object that is advantageously at least partially arranged on the constructional unit, and/or dynamic forces of the object, such as for example acceleration forces, in particular during an operation of the aircraft, and/or externally acting forces, such as for example impact forces, at least partially and preferably at least to a great extent, and advantageously, in at least one fitted state and/or at least one operating state, introducing them, in particular indirectly and/or directly, into at least one supporting structure of the aircraft, such as for example a floor, a ceiling, a side wall, a baggage compartment and/or any other structural component of the aircraft. The load-bearing constructional unit may in this case be formed as any load-bearing constructional unit, such as for example at least as part of a serving tray, an airline cart, a safety latch, a dividing wall, a door, a flap, a window and/or advantageously a seat component, such as for example a seat frame, a table, a table fixing means, a backrest, an armrest, a sitting surface and/or a seat divider or the like. In particular, the aircraft seat and/or the aircraft device may also have a number of load-bearing constructional units, in particular which are coupled to one another and advantageously are substantially of the same construction, and which advantageously form a common basic structure. The expression “at least to a great extent” is to be understood in this case as meaning in particular at least 55%, advantageously at least 65%, preferably at least 75%, particularly preferably at least 85% and particularly advantageously at least 95%. Objects that are “at least substantially of the same construction” are to be understood as meaning in particular objects that are at least substantially constructed identically to one another, but may at least partially differ from one another, in particular in at least one feature, such as for example an outer form, an internal structure, a load to be borne and/or a way of functioning.

In addition, an “outer subregion” of the load-bearing constructional unit is to be understood as meaning in particular a part of an outer region and/or a part of a vicinity of a surface region of the load-bearing constructional unit. Particularly preferably, the outer subregion has a volume that corresponds to at least 10%, preferably at least 20%, particularly preferably at least 30% and particularly advantageously at least 50%, of an overall volume of the load-bearing constructional unit. Preferably, the outer subregion delimits and/or defines an outer surface of the load-bearing constructional unit at least partially. Particularly preferably, the outer subregion in this case extends over at least 10%, preferably over at least 20%, particularly preferably over at least 30% and particularly advantageously over at least 50% of an entire outer surface of the load-bearing constructional unit. In particular, the load-bearing constructional unit may in this case also consist at least to a great extent and/or completely of the plastic reinforced with reinforcing fibers. The plastic may be any thermosetting and/or advantageously thermoplastic material, such as for example polycarbonates (PC), polyether imide (PEI), polyphenylene sulfide (PPS) and/or particularly preferably polyetherether ketone (PEEK). In addition, the reinforcing fibers may in particular at least partially, preferably at least to a great extent and particular preferably completely, consist of carbon, graphite, glass, ceramic and/or aramid. Furthermore, the expression “at least substantially homogeneously” is to be understood as meaning in particular homogeneously at least in certain portions and/or partially. In particular, the reinforcing fibers could in this case also be distributed at least partially inhomogeneously in the outer subregion. Preferably, however, apart from production tolerances and/or within the technical possibilities of production and/or within standardized tolerances, the reinforcing fibers are distributed homogeneously over the entire outer subregion.

According to a further aspect of the invention, which can be realized in particular on its own or advantageously in addition to the aforementioned aspect of the invention, an aircraft device, in particular an aircraft seat device, is proposed, with a load-bearing constructional unit, which in at least one outer subregion of the constructional unit consists of a plastic reinforced with reinforcing fibers, wherein the outer subregion has essential load-bearing properties. As a result, in particular the advantages already mentioned above can be achieved. In particular, a corresponding refinement of the aircraft device allows an efficiency, in particular a production efficiency, a component efficiency, a weight efficiency and/or a cost efficiency, to be improved. Moreover, a stability can be advantageously increased and/or a weight of the aircraft device can be advantageously reduced. In addition, a flexibility, in particular a design flexibility, can be advantageously improved. In this connection, the expression “essential load-bearing properties” is to be understood as meaning in particular that the outer subregion is configured to bear at least 10%, advantageously at least 30% and particularly preferably at least 50%, of an overall load acting on the load-bearing constructional unit.

It is also proposed that the, in particular load-bearing, constructional unit has at least one structural unit that at least substantially defines a form of the constructional unit and has the outer subregion. That “the structural unit at least substantially defines a form of the constructional unit” is to be understood as meaning in particular that the structural unit at least to a great extent replicates the outer surface of the load-bearing constructional unit. Preferably, the structural unit in this case forms a main body of the, in particular load-bearing, constructional unit. As a result, in particular an advantageously flexible load-bearing constructional unit, which can in particular be optimized by means of further add-on elements and/or functional elements, can be provided.

Furthermore, it is proposed that the structural unit at least to a great extent and particularly preferably completely consists of the plastic reinforced with reinforcing fibers, wherein the reinforcing fibers are distributed at least substantially homogeneously over the entire structural unit. In particular, the reinforcing fibers could in this case also be distributed at least partially inhomogeneously in a subregion of the structural unit. Preferably, however, apart from production tolerances and/or within the technical possibilities of production and/or within standardized tolerances, the reinforcing fibers are distributed homogeneously over the entire structural unit. As a result, in particular an advantageously high stability can be achieved.

If the structural unit forms a hollow profile that is at least to a great extent closed, in particular a weight efficiency can be improved. Moreover, the structural unit can in particular be adapted particularly easily to different requirements and/or needs.

According to a further refinement of the invention, it is proposed that the structural unit has at least one predetermined breaking structure. The structural unit could in this case have a number of predetermined breaking structural elements that are displaceable with respect to one another, which in particular form the predetermined breaking structure and in at least one operating state can advantageously be plastically deformed and/or destroyed. Preferably, the predetermined breaking structure has however just one predetermined breaking structural element, which is formed as a cross, strip and/or particularly preferably a honeycomb, which in particular is configured to undergo a defined deformation and/or destruction in at least one operating state. As a result, in particular a particularly high operational reliability can be achieved. Moreover, in particular an aircraft device that is adaptable to different safety standards can be provided.

A particularly high stability and/or a particularly efficient production can be achieved in particular if the structural unit is formed in one piece. “In one piece” is to be understood in this context as meaning in particular at least connected in a material-bonding manner and/or formed with one another. The material bond may be produced for example by an adhesive-bonding process, a molding-on process, a welding process, a soldering or brazing process and/or some other process. Advantageously, in one piece is to be understood as meaning formed from one piece and/or in one piece. Preferably, this one piece is produced from a single blank, a compound and/or a molding material, such as for example in an extrusion process, in particular a one- and/or multi-component extrusion process, and/or an injection-molding process, in particular a one- and/or multi-component injection-molding process. Particularly preferably, the structural unit is in this case formed as an injection-molded part.

In addition, it is proposed that the structural unit has at least two structural elements, which are formed as at least substantially corresponding to one another. The structural elements may in this case for example consist at least partially of different materials, whereby in particular an advantageous diversity and/or flexibility can be achieved. Preferably, the structural elements however consist of a same material, in particular the plastic reinforced with the reinforcing fibers, whereby in particular easy production can advantageously be achieved. Objects that are “at least substantially corresponding” are to be understood in this case as meaning in particular objects which have external forms that are at least in certain portions formed as corresponding to one another, but in particular may differ from one another in at least one feature. Advantageously, the structural elements may in this case be formed mirror-symmetrically or, apart from production tolerances and/or within the technical possibilities of production and/or within standardized tolerances, identically to one another.

According to a particularly preferred refinement of the invention, it is proposed that the constructional unit has at least one add-on unit that is connectable and/or is connected to the structural unit and preferably reinforces the structural unit, whereby in particular a fatigue strength and/or a service life of the aircraft device can be further improved. Alternatively or in addition, in particular an appearance of the load-bearing constructional unit can be advantageously adapted to different requirements. An “add-on element” is to be understood in this case as meaning in particular a unit with at least one add-on element which is in operative connection with the structural unit, advantageously the outer surface of the structural unit, and in particular is connected to the structural unit in a form-fitting, force-fitting and/or material-bonding manner. Preferably, the add-on unit consists at least partially and preferably to a great extent of a material that differs from a material of the structural unit. Particularly preferably, the add-on unit consists at least partially and preferably at least to a great extent of a metal, advantageously steel and/or aluminum, a metal alloy, a ceramic and/or a high-strength plastic. Moreover, the add-on unit may advantageously comprise a number of add-on elements, such as for example at least two, at least five and/or at least eight add-on elements. Moreover, the add-on unit may also comprise at least one add-on element which may for example be formed as a design element, in particular a design film or the like.

If the add-on unit has at least one add-on element, which is configured to reinforce a coupling structure of the structural unit, in particular for coupling to a further object, in particular an advantageously secure coupling of the structural unit to the further object can be achieved. Advantageously, the add-on element is in this case formed as at least substantially cylindrical, at least substantially spiral and/or at least substantially helical. An object that is “at least substantially cylindrical” is to be understood in this context as meaning in particular an object that differs from a cylindrical reference object with a proportion of its volume of at most 20%, preferably of at most 15% and particularly preferably of at most 10%. The same is configured in particular to apply correspondingly to the expressions “at least substantially spiral” and “at least substantially helical”.

It is also proposed that the add-on unit has at least one add-on element, preferably formed as at least substantially cylindrical and/or as a strip, in particular the already previously mentioned add-on element and/or a further add-on element, which is configured to reinforce a main supporting structure of the structural unit. In particular, for reinforcing the main supporting structure, the add-on element is in this case arranged in a region of the structural unit in which a greatest loading acts on the structural unit and/or a greatest load has an effect on the structural unit. Advantageously, the add-on element may in this case have retaining elements, such as for example retaining pins, which are configured for a coupling and/or a fastening of the add-on element on the structural unit. As a result, in particular a stability of the structural unit and/or of the load-bearing constructional unit can be further optimized.

In addition, it is proposed that the add-on unit has at least one add-on element, preferably formed as a strip and/or formed as clips and/or clamps, in particular the already previously mentioned add-on element and/or an additional add-on element, which is configured to connect at least two structural elements of the structural unit, advantageously the already previously mentioned structural elements, to one another. As a result, in particular an advantageously easy and/or flexible connection of the structural elements of the structural unit can be achieved.

In a further refinement of the invention, it is proposed that the, in particular load-bearing, structural unit has at least one functional unit that is at least partially, preferably to a great extent and particularly preferably completely, embedded in the structural unit. Preferably, the functional unit is in this case overmolded with the structural unit. A “functional unit” is to be understood in this case as meaning in particular a unit which is configured to perform at least one function, in particular associated with the aircraft and advantageously the aircraft seat, in at least one operating state. The function may in this case be any function, such as for example a reinforcing function, a moving function, an illuminating function, a fastening function and/or a bearing function. As a result, in particular a particularly flexible aircraft device can be provided.

Furthermore, it is proposed that the functional unit has at least one, advantageously at least substantially cylindrical, supporting element, which is configured for supporting, in particular internally reinforcing, the structural unit, whereby in particular a stability of the aircraft device can be further improved. Particularly advantageously, the supporting element consists in this case at least partially, preferably at least to a great extent and particularly preferably completely, of a metal, a metal alloy, a ceramic and/or a plastic, in particular a high-strength plastic and/or a fiber-reinforced plastic. Advantageously, the supporting element may also be produced by means of a 3D printing process, whereby in particular an advantageously easy and/or quick production of the supporting element can be achieved and at the same time complicated structures can be produced. In addition, the supporting element is particularly advantageously provided at least in certain portions with clearances and/or holes and in particular is formed in a perforated manner, as a loop and/or as a mesh, whereby in particular a weight of the structural element can be further reduced.

It is also proposed that the functional unit has at least one hinge element, which is configured to connect at least two structural elements of the structural unit, advantageously the already previously mentioned structural elements, movably to one another, in particular in such a way that the structural elements are movable in relation to one another. As a result, in particular an advantageously flexible and/or movable load-bearing constructional unit can be provided.

Moreover, the invention concerns a method for coupling the load-bearing constructional unit to at least one further object, preferably a further load-bearing constructional unit, advantageously at least substantially of the same construction, wherein the load-bearing constructional unit is coupled to the at least one further object in at least one method step by means of a process that is in particular different from overmolding, such as an injection-molding and/or compression-molding process, in particular in order to form a common basic structure, for example of an aircraft seat. Advantageously, the load-bearing constructional unit and the at least one further object are in this case coupled to one another in such a way that the load-bearing constructional unit and the at least one further object form an at least substantially homogeneous structure and/or subassembly.

Preferably, any number of load-bearing constructional units, advantageously at least substantially of the same construction, may be coupled to one another by means of the injection-molding and/or compression-molding process. As a result, in particular an efficiency, in particular a production efficiency, a component efficiency, a weight efficiency and/or a cost efficiency, can be improved. Moreover, advantageously a stability can be increased and/or a weight of the aircraft device can be reduced. In addition, advantageously a flexibility, in particular a design flexibility, can be improved.

The aircraft device and the method for producing the aircraft device are not configured here to be restricted to the application and embodiment described above. In particular, the aircraft device and the method for producing the aircraft device may have a number of individual elements, components and units that differ from the number mentioned herein in order to perform a way of functioning described herein.

### DRAWINGS

Further advantages will become evident from the following description of the drawings. The drawings illustrate an exemplary embodiment of the invention. The drawings, the description and the claims contain numerous features in combination. A person skilled in the art will also expediently consider the features individually and combine them to form meaningful further combinations.

In the figures:

FIGS. 1a-b show an aircraft with an aircraft seat which is arranged within the aircraft and comprises at least one aircraft device,

FIG. 2 shows a load-bearing constructional unit of the aircraft device that is formed by way of example as an armrest in a perspective representation, wherein the load-bearing constructional unit comprises at least one structural unit and an add-on unit,

FIG. 3 shows a material composition of the structural unit in a view of a detail,

FIG. 4 shows a predetermined breaking structure of the structural unit in a schematic representation,

FIG. 5 shows a supporting element of a functional unit of the load-bearing constructional unit that is embedded in the structural unit,

FIGS. 6a-b show a hinge element of the functional unit embedded in the structural unit for the movable coupling of two structural elements of the structural unit,

FIG. 7 shows a method given by way of example for coupling the constructional unit to at least one further object,

FIG. 8 shows a further exemplary embodiment of a load-bearing constructional unit of an aircraft device that is formed by way of example as a seat divider,

FIG. 9 shows the load-bearing constructional unit from FIG. 8 in a representation of a detail,

FIG. 10 shows the load-bearing constructional unit from FIGS. 8 and 9 in a sectional representation along the line X-X in FIG. 9,

FIG. 11 shows a further exemplary embodiment of a load-bearing constructional unit of an aircraft device that is formed by way of example as a seat divider,

FIG. 12 shows the load-bearing constructional unit from FIG. 11 in a sectional representation,

FIG. 13 shows an add-on element of an add-on unit of the aircraft device from FIGS. 11 and 12,

FIG. 14 shows a further exemplary embodiment of a load-bearing constructional unit of an aircraft device that is formed by way of example as a seat divider and

FIG. 15 shows the load-bearing constructional unit from FIG. 14 in a sectional representation along the line XV-XV in FIG. 14.

### DESCRIPTION OF THE EXEMPLARY EMBODIMENTS

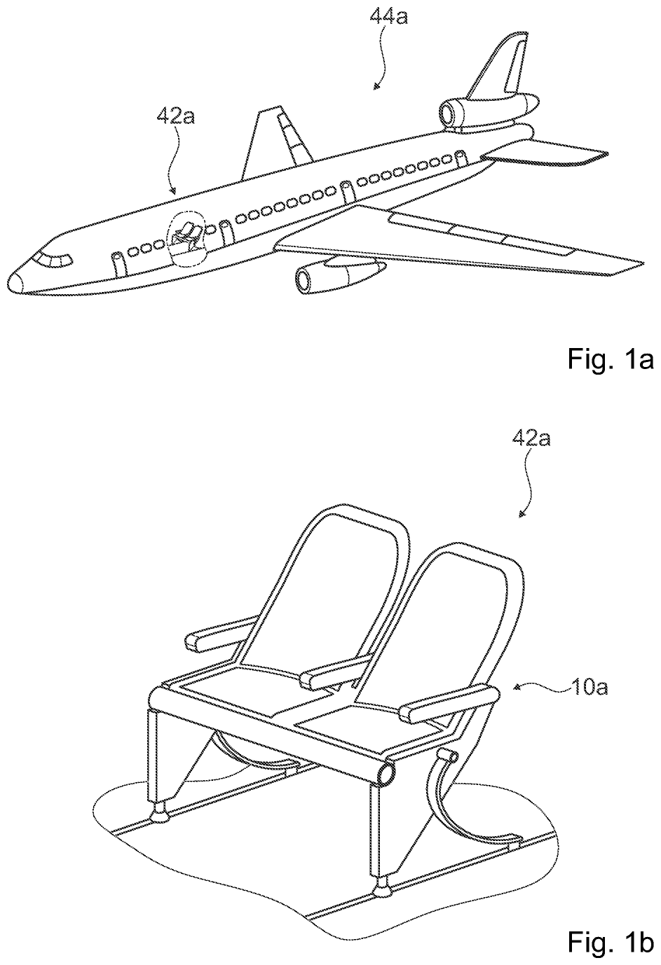

FIGS. 1a and 1 b show an aircraft 44a, which is formed by way of example as a passenger aircraft and comprises at least one aircraft seat 42a with an aircraft device. Alternatively, an aircraft could however also be formed as a transport aircraft, as a glider, as a helicopter and/or as an airship or the like. Moreover, an aircraft device may also be formed as part of any other cabin component of an aircraft, such as for example as part of a dividing wall and/or of a safety door or the like.

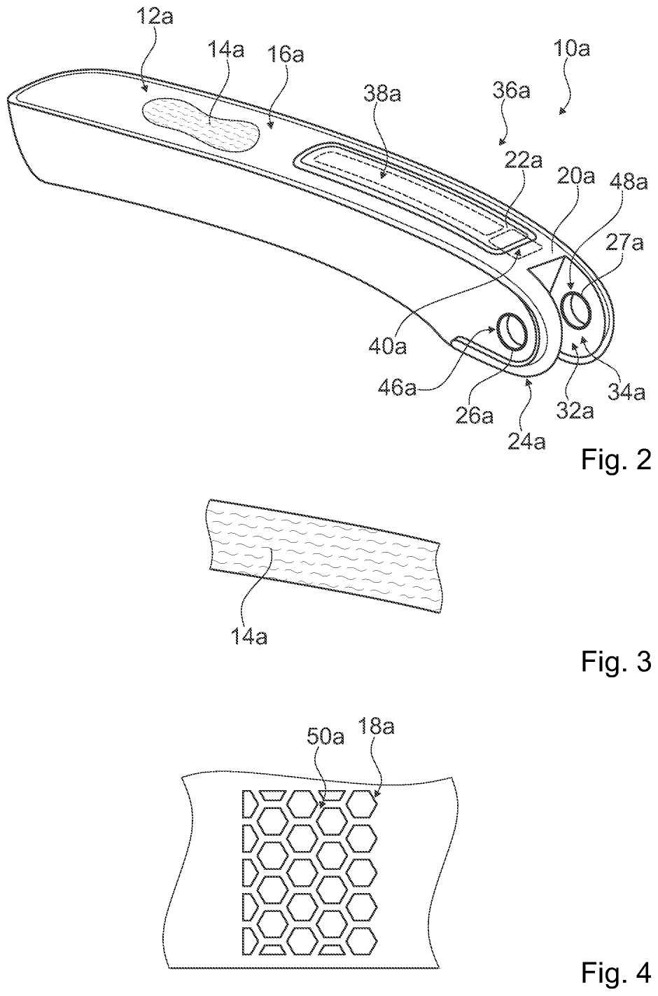

The aircraft device comprises at least one load-bearing constructional unit 10a. The constructional unit 10a is formed as a cabin component of the aircraft 44a. The constructional unit 10a is in the present case formed by way of example as an armrest (cf. also FIG. 2). The constructional unit 10a is configured to absorb a stress of at least 50 MPa, in particular without thereby being deformed and/or destroyed, and in particular in a fitted state introducing them indirectly into a supporting structure of the aircraft 44a. Alternatively, a load-bearing constructional unit could however also be formed at least as part of a serving tray, an airline cart, a safety latch, a folding table, a backrest, a torsion profile, a torsion tube and/or a seat divider or the like.

The constructional unit 10a consists at least in an outer subregion 12a of a plastic reinforced with reinforcing fibers 14a. The outer subregion 12a delimits and/or defines an outer surface of the load-bearing constructional unit 10a. Alternatively or in addition, an additional layer and/or coating could however also be applied above the outer subregion, for example in the form of a paint, a lacquer and/or a film. The outer subregion 12a extends in this case over at least 80% and preferably over at least 90% of an entire outer surface of the load-bearing constructional unit 10a. The outer subregion 12a also has essential load-bearing properties. In the present case, the constructional unit 10a consists at least to a great extent of plastic reinforced with reinforcing fibers 14a. The reinforcing fibers 14 are in this case distributed at least substantially homogeneously over the constructional unit 10a. FIG. 3 shows part of the material of the constructional unit 10a with the reinforcing fibers 14a arranged therein. The reinforcing fibers 14a are arranged in the material of the constructional unit 10a in such a way that the reinforcing fibers 14a are distributed homogeneously, at least in the outer subregion 12a. The plastic reinforced with the reinforcing fibers 14a is in the present case polyetherether ketone (PEEK), which is reinforced with reinforcing fibers 14a of carbon. Alternatively, a plastic reinforced with reinforcing fibers could however also be polyether imide (PEI) and/or polyphenylene sulfide (PPS) or the like. Moreover, reinforcing fibers could consist of graphite, glass, ceramic and/or aramid.

The constructional unit 10a has a structural unit 16a. The structural unit 16a forms a main body of the constructional unit 10a. The structural unit 16a defines at least substantially a form of the constructional unit 10a. The structural unit 16a has the outer subregion 12a. In the present case, the structural unit 16a forms a hollow profile that is to the greatest extent closed. Alternatively, a structural unit could however also form a U profile, which may be completed by means of a closure element and/or a covering element to form a closed hollow profile. The structural unit 16a consists completely of the plastic reinforced with the reinforcing fibers 14a. The reinforcing fibers 14a are in this case distributed at least substantially homogeneously over the entire structural unit 16a. Alternatively, a structural unit could however also form a solid body and/or merely consist partially of a plastic reinforced with the reinforcing fibers.

The structural unit 16a has a coupling structure 32a. The coupling structure 32a has in the present case by way of example two coupling elements 46a, 48a, formed in particular as coupling clearances. The coupling elements 46a, 48a are formed as cylindrical clearances. The coupling structure 32a is configured for coupling to a further component of the aircraft seat 42a. The coupling structure 32a is configured for connecting the structural unit to the further component of the aircraft seat 42a. In principle, the structural unit could however also be free from a coupling structure. Moreover, a coupling structure could have a different number of coupling elements, such as for example just one coupling element or at least three coupling elements. Furthermore, it is conceivable to form at least one coupling element as a bolt. In addition, at least one coupling element could be formed as a hemisphere, as a cuboid or as a fork part. Moreover, coupling elements may preferably be molded together with sheet-like coupling plates.

The structural unit 16a also has a main supporting structure 34a. The main supporting structure 34a of the structural unit 16a corresponds in this case to a portion of the structural unit 16a on which a greatest loading acts and/or a greatest load has an effect. The main supporting structure 34a of the structural unit 16a is in the present case identical to the coupling structure 32a. In principle, a main supporting structure could however also be arranged in a region of a structural unit different from a coupling structure.

In addition, the structural unit 16a may have a predetermined breaking structure 18a (cf. also FIG. 4). The predetermined breaking structure 18a is configured for weakening the structural unit 16a in a defined region. The predetermined breaking structure 18a is arranged in a region, in particular a vicinity, of the main supporting structure 34a. The predetermined breaking structure 18a is configured to undergo a defined deformation and/or destruction in at least one operating state. For this purpose, the predetermined breaking structure 18a has at least one predetermined breaking structural element 50a. The predetermined breaking structural element 50a is formed as a honeycomb. In principle, a structural unit could however also be free from a predetermined breaking structure or have further predetermined breaking structures. A predetermined breaking structure could also be arranged in a different region of a structural unit. Moreover, a predetermined breaking structure also have a different number of predetermined breaking structural elements, such as for example at least two, at least three and/or at least four predetermined breaking structural elements, which could advantageously be arranged spaced apart from one another. Furthermore, it is conceivable to form at least one predetermined breaking structural element as a cross and/or as a strip.

Furthermore, the structural unit 16a is in the present case of a multi-part form. The structural unit 16a has in this case at least two structural elements 20a, 22a, in particular a first structural element 20a and a second structural element 22a. The structural elements 20a, 22a are formed as corresponding to one another. The structural elements 20a, 22a are formed in each case in one piece, in particular as injection-molded parts. The structural elements 20a, 22a consist of the same material, in particular the plastic reinforced with the reinforcing fibers 14a. The structural elements 20a, 22a delimit and/or define in each case a part of the outer surface of the load-bearing constructional unit 10a. The structural elements 20a, 22a are also movably connected to one another, in particular in such a way that the structural elements 20a, 22a can be moved relatively with respect to one another. Alternatively, a structural unit could however also be formed in one piece and in particular consist of one piece and/or be produced in one piece. In this case it is for example conceivable to form the structural unit as a one-piece injection-molded part. Moreover, at least two structural elements could also at least partially consist of different materials and/or be immovably connected to one another.

In addition, the constructional unit 10a has an add-on unit 24a. The add-on unit 24a consists in the present case of a material that is different from a material of the structural unit 16a. The add-on unit 24a consists by way of example of a metal alloy, in particular an aluminum alloy. The add-on unit 24a is connectable to the structural unit 16a. In a fitted state, the add-on unit unit 24a has an operative connection to the structural unit 16a, in particular the outer surface of the structural unit 16a. In the present case, the add-on unit 24a is configured to reinforce the structural unit 16a.

For this purpose, the add-on unit 24a comprises at least one add-on element 26a, 27a. In the present case, the add-on unit 24a comprises two add-on elements 26a, 27a. The add-on elements 26a, 27a are at least substantially identical to one another. The add-on elements 26a, 27a are formed as cylindrical, in particular hollow-cylindrical, and/or tubular. The add-on elements 26a, 27a are formed as sleeves. The add-on elements 26a, 27a are formed in each case in one piece. Each of the add-on elements 26a, 27a is assigned to one of the coupling elements 46a, 48a. In the fitted state, the add-on elements 26a, 27a are in each case connected to one of the coupling elements 46a, 48a in a form-fitting and/or force-fitting manner, in particular by means of a pressed connection. The add-on elements 26a, 27a are configured to reinforce the coupling structure 32a of the structural unit 16a and/or to form a defined load path and/or force introduction path. Moreover, the add-on elements 26a, 27a are configured to reinforce the main supporting structure 34a of the structural unit 16a. Alternatively, an add-on unit or at least one add-on element could however also consist at least partially of a same material as a structural unit and/or of a material different from a metal alloy. Moreover, an add-on unit and/or at least one add-on element could be connected to a structural unit in a material-bonding and/or integral manner. In this connection, it is in particular also conceivable to overmold an add-on unit and/or at least one add-on element at least partially with a structural unit. Furthermore, add-on elements could be exclusively configured to reinforce a coupling structure or a main supporting structure of a structural unit. In addition, an aircraft device could in principle also be free from an add-on unit.

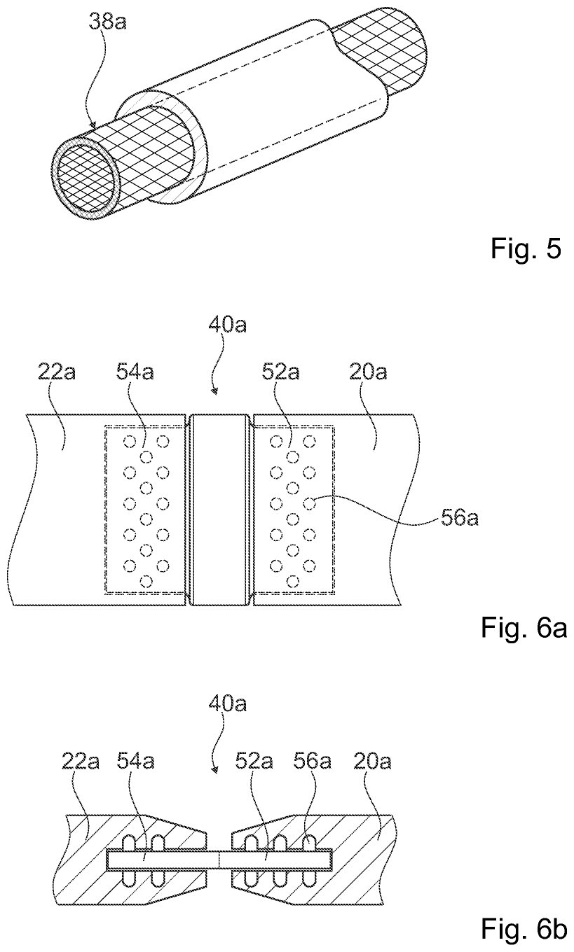

The constructional unit 10a also comprises a functional unit 36a (cf. in particular FIGS. 5, 6a and 6b). The functional unit 36a is at least to a great extent embedded in the structural unit 16a. The functional unit 36a is at least to a great extent enclosed by the structural unit 16a.

The functional unit 36a comprises at least one supporting element 38a (cf. in particular FIG. 5). The supporting element 38a is completely embedded in the structural unit 16a. In the present case, the supporting element 38a is by way of example embedded in the second structural element 22a. Alternatively, a supporting element could however also be arranged in any other region of a supporting unit. The supporting element 38a is formed at least substantially as cylindrical, in particular hollow-cylindrical and/or tubular. The supporting element 38a is formed in one piece. The supporting element 38a consists of a metal alloy, in the present case in particular an aluminum alloy. The supporting element 38a is also produced by means of a 3D printing process. The supporting element 38a is also formed in a perforated manner and/or as a mesh, whereby in particular a weight of the supporting element 38a can be reduced. The supporting element 38a is in this case configured for supporting and/or internally reinforcing the structural unit 16a. Alternatively, a supporting element could however also consist of a material different from an aluminum alloy, such as for example plastic, and/or have a different form, which is advantageously adapted to an outer form of a constructional unit and/or of a structural unit. In particular, a supporting element could in this case be formed for example as a U profile, C profile, L profile and/or I profile. Moreover, a supporting element could have a number of retaining elements, whereby a retaining force between the supporting element and a structural unit can be improved. In addition, it is in principle conceivable to dispense with a supporting element completely.

The functional unit 36a also comprises at least one hinge element 40a (cf. in particular FIGS. 6a and 6b). The hinge element 40a is at least to a great extent embedded in the structural unit 16a. The hinge element 40a consists of a metal alloy, in the present case in particular a spring steel alloy. The hinge element 40a comprises two fittings 52a, 54a, wherein a first fitting 52a of the fittings 52a, 54a is connected to the first structural element 20a of the structural elements 20a, 22a and a second fitting 54a of the fittings 52a, 54a is connected to the second structural element 22a of the structural elements 20a, 22a. The hinge element 40a in this case connects the structural elements 20a, 22a movably to one another.

The hinge element 40a also comprises a number of retaining elements 56a for intensifying a retaining force between the hinge element 40a and the structural unit 16a. The retaining elements 56a are formed as retaining pins. In the present case, each of the fittings 52a, 54a is assigned a number of the retaining elements 56a. Alternatively, a hinge element could however also consist of a material different from a spring steel alloy and be formed as a film hinge. Moreover, a hinge element could also comprise retaining elements formed as retaining clearances or be free from retaining elements. In addition, it is in principle conceivable to dispense with a hinge element completely.

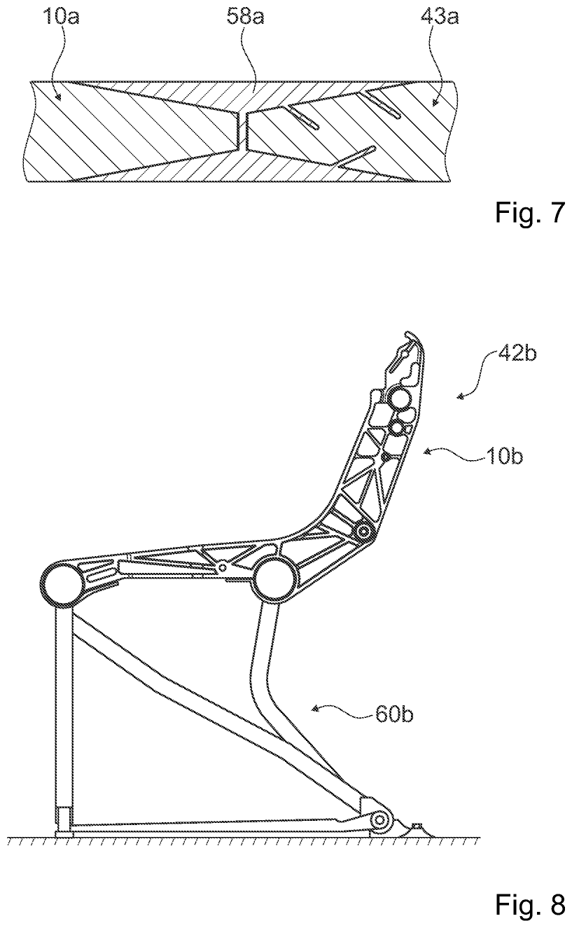

FIG. 7 also shows a method, given by way of example, for coupling the load-bearing constructional unit 10a of the aircraft device to at least one further object 43a. The further object 43a may in this case be in particular a further load-bearing constructional unit that is at least substantially of the same construction as the constructional unit 10a. For the coupling, the constructional unit 10a and the at least one further object 43a are arranged in direct proximity to one another and the constructional unit 10a is subsequently coupled to the at least one further object 43a by means of a process that is different from overmolding, such as an injection-molding and/or compression-molding process, in particular in such a way that the constructional unit 10a and the at least one further object 43a form an at least substantially homogeneous structure and/or subassembly. The constructional unit 10a and the at least one further object 43a may in this case form for example a common basic structure of the aircraft seat 42a.

In the present case, the load-bearing constructional unit 10a is coupled to the at least one further object 43a by means of an injection-molding process. In this case, a coupling material 58a is used for the coupling of the constructional unit 10a and the at least one further object 43a. A plastic, such as for example a reinforced and/or unreinforced thermoset and/or thermoplastic, may be used in this case as the coupling material 58a.

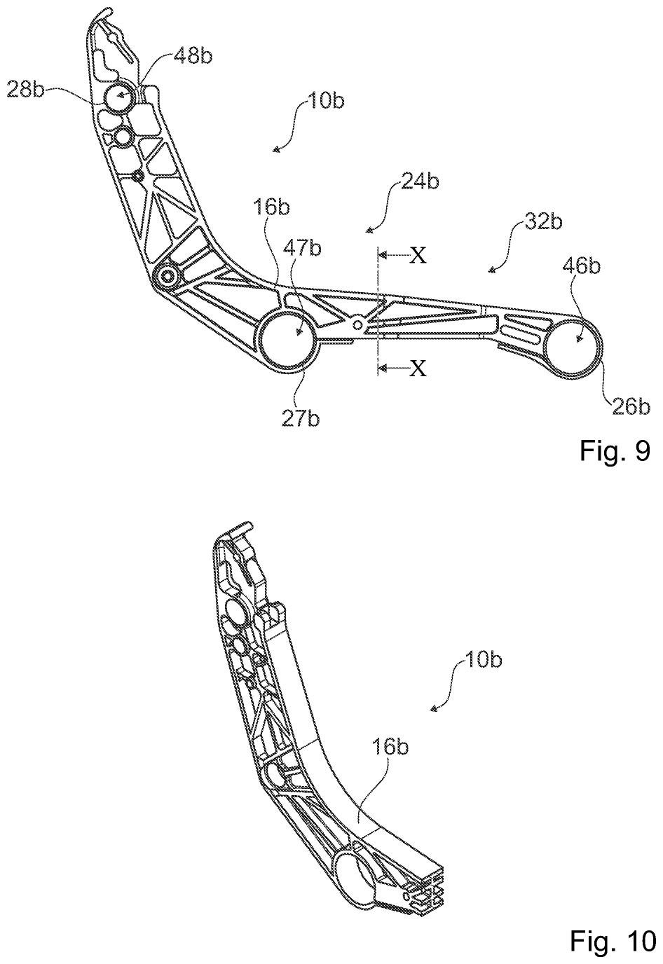

In FIGS. 8 to 15, further exemplary embodiments of the invention are shown. The following descriptions and the drawings are restricted substantially to the differences between the exemplary embodiments, it being possible in principle also to refer to the drawings and/or the description of the other exemplary embodiments, in particular of FIGS. 1 to 7, with respect to components with the same designations, in particular with respect to components with the same reference numerals. To distinguish between the exemplary embodiments, the letter a has been added after the reference numerals of the exemplary embodiment in FIGS. 1 to 7. In the exemplary embodiments of FIGS. 8 to 15, the letter a has been substituted by the letters b to d.

In FIGS. 8 to 10, a further exemplary embodiment of the invention is shown. In the exemplary embodiment of FIGS. 8 to 10, the letter b has been added. The further exemplary embodiment of FIGS. 8 to 10 differs from the previous exemplary embodiment at least substantially by a particular type of load-bearing constructional unit 10b.

The constructional unit 10b is formed in the present case by way of example as a seat divider. The constructional unit 10b is in this case configured to absorb a stress of at least 100 MPa, in particular without thereby being deformed and/or destroyed, and in particular in a fitted state introducing it indirectly, in particular via a base structure 60b of an aircraft seat 42b, into a floor of an aircraft.

The constructional unit 10b has a structural unit 16b that defines a form of the constructional unit 10b and consists completely of a plastic reinforced with reinforcing fibers, wherein the reinforcing fibers are distributed at least substantially homogeneously over the entire structural unit 16b. The structural unit 16b is formed as a solid body. The structural unit 16b is formed in one piece. In the present case, the structural unit 16b is formed as an injection-molded part. The structural unit 16b consists in the present case of PEEK 90HMF40.

The structural unit 16b also has a coupling structure 32b, which in the present case has at least three coupling elements 46b, 47b, 48b, formed in particular as coupling clearances.

In addition, the constructional unit 10b has an add-on unit 24b, wherein each of the coupling elements 46b, 47b, 48b is assigned an add-on element 26b, 27b, 28b. The add-on elements 26b, 27b, 28b are at least substantially identical to the add-on elements 26a, 27b of the previous exemplary embodiment and are configured to reinforce the coupling structure 32b of the structural unit 16b.

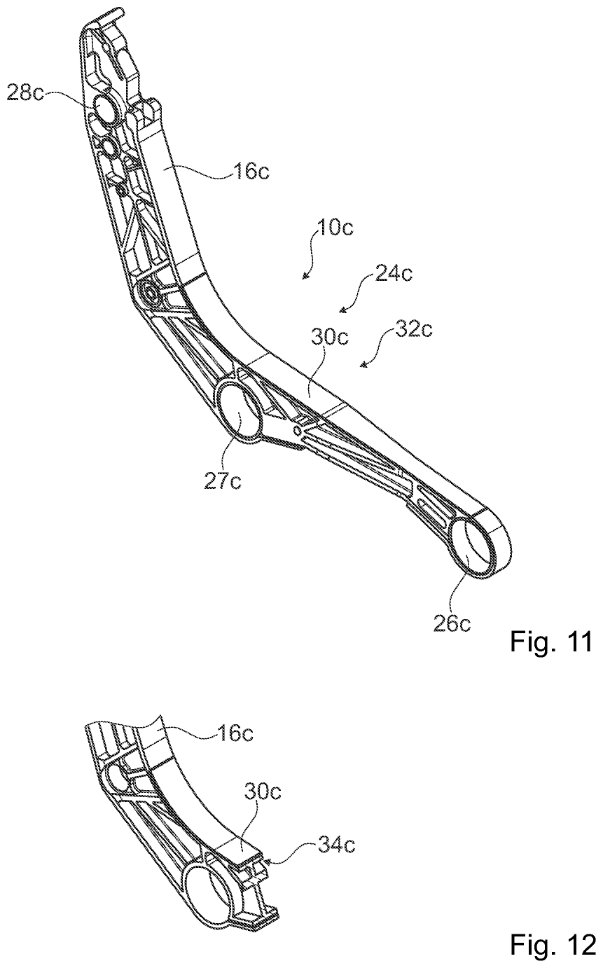

In FIGS. 11 to 13, a further exemplary embodiment of the invention is shown. In the exemplary embodiment of FIGS. 11 to 13, the letter c has been added. The further exemplary embodiment of FIGS. 11 to 13 differs from the previous exemplary embodiments at least substantially by a refinement of an add-on unit 24c.

A load-bearing constructional unit 10c is in the present case formed in turn by way of example as a seat divider and comprises a structural unit 16c and also the add-on unit unit 24c.

in this case, the add-on unit 24c comprises three add-on elements 26c, 27c, 28c, which are configured to reinforce a coupling structure 32c of the structural unit 16c.

Moreover, the add-on unit 24c comprises a further add-on element 30c, which is configured to reinforce a main supporting structure 34c of the structural unit 16c. To reinforce the main supporting structure 34c, the further add-on element 30c is arranged in a region of the structural unit 16c in which a greatest loading acts on the structural unit 16c and/or a greatest load has an effect on the structural unit 16c. The further add-on element 30c is formed as a strip. The further add-on element 30c consists of a metal, in the present case in particular a high-strength steel. In a fitted state, the further add-on element 30c is connected to the structural unit 16c, in particular the main supporting structure 34c of the structural unit 16c, in a form-fitting manner.

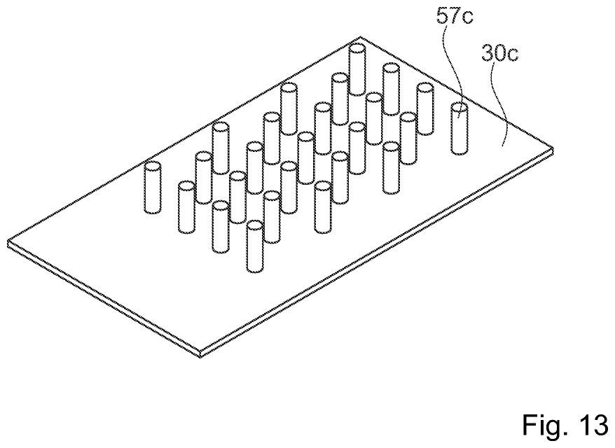

Moreover, the further add-on element 30c has a number of further retaining elements 57c, which in the present case are formed in particular as retaining pins and are configured for coupling and/or fastening the further add-on element, 30c on the structural unit 16c (cf. FIG. 13). Alternatively, a further add-on element could however also be formed free from further retaining elements and for example be connected to a structural unit in a material-bonding manner.

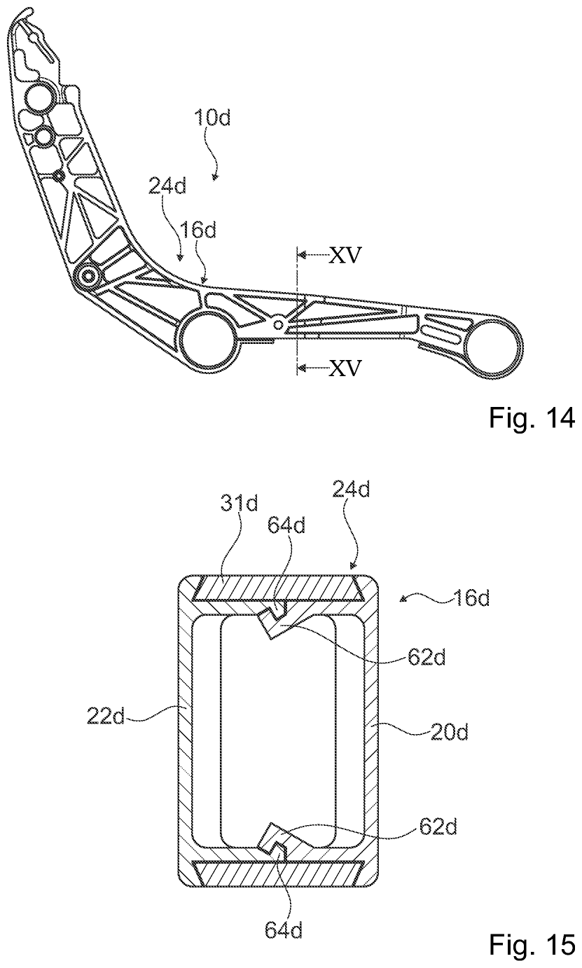

In FIGS. 14 and 15, a further exemplary embodiment of the invention is shown. In the exemplary embodiment of FIGS. 14 and 15, the letter d has been added. The further exemplary embodiment of FIGS. 14 and 15 differs from the previous exemplary embodiments at least substantially by a refinement of a load-bearing constructional unit 10d.

The constructional unit 10d is in the present case formed by way of example as a seat divider. The constructional unit 10d has a structural unit 16d that defines a form of the constructional unit 10d.

The structural unit 16d has at least two structural elements 20d, 22d. The structural elements 20d, 22d are formed as corresponding to one another. In the present case, the structural elements 20d, 22d are formed at least substantially mirror-symmetrically to one another. The structural elements 20d, 22d are in each case formed in one piece. The structural elements 20d, 22d are formed as injection-molded parts.

The structural elements 20d, 22d have connecting elements 62d, 64d corresponding to one another. The connecting elements 62d, 64d are formed as clips corresponding to one another. In a fitted state, the structural elements 20d, 22d are connected to one another by means of the connecting elements 62d, 64d in an immovable and load-bearing manner, in particular in such a way that the structural elements 20d, 22d form a hollow profile.

In addition, the constructional unit 10d has an add-on unit 24d. The add-on unit 24d comprises at least one additional add-on element 31d, which is configured to connect the structural elements 20d, 22d to one another. The additional add-on element 31d is in the present case formed as a strip. The additional add-on element 31d consists of a fiber-reinforced plastic, in the present case in particular a carbon-fiber-reinforced plastic. The additional add-on element 31d is formed as an adhesively bonding element. In a fitted state, to connect the structural elements 20d, 22d, the additional add-on element 32d is connected to the structural elements 20d, 22d in a material-bonding manner. Alternatively, to connect two structural elements, an add-on element could however also be formed as a clamp and/or be connected to the structural elements in a force- and/or form-fitting manner. Also, an additional add-on element could consist of a material different from a fiber-reinforced plastic, such as for example a metal, in particular a metal provided with an adhesive film.

1. An aircraft device, in particular an aircraft seat device, with at least one load-bearing constructional unit, which in at least one outer subregion of the constructional unit consists of a plastic reinforced with reinforcing fibers, wherein the reinforcing fibers are distributed at least substantially homogeneously over the entire outer subregion.

2. The aircraft device as claimed in claim 1, wherein the outer subregion has essential load-bearing properties.

3. The aircraft device as claimed in claim 1, wherein the constructional unit has at least one structural unit that at least substantially defines a form of the constructional unit and has the outer subregion.

4. The aircraft device as claimed in claim 3, wherein the structural unit consists at least to a great extent of the plastic reinforced with reinforcing fibers, wherein the reinforcing fibers are distributed at least substantially homogeneously over the entire structural unit.

5. The aircraft device as claimed in claim 3, wherein the structural unit forms a hollow profile that is at least to a great extent closed.

6. The aircraft device as claimed in claim 3, wherein the structural unit has at least one predetermined breaking structure.

7. The aircraft device as claimed in claim 3, wherein the structural unit is formed in one piece.

8. The aircraft device as claimed in claim 3, wherein the structural unit has at least two structural elements, which are formed as at least substantially corresponding to one another.

9. The aircraft device as claimed in claim 3, wherein the constructional unit has at least one add-on unit that is connectable and/or is connected to the structural unit.

10. The aircraft device as claimed in claim 9, wherein the add-on unit has at least one add-on element, which is configured to reinforce a coupling structure of the structural unit.

11. The aircraft device as claimed in claim 9, wherein the add-on unit has at least one add-on element, which is configured to reinforce a main supporting structure of the structural unit.

12. The aircraft device as claimed in claim 9, wherein the add-on unit has at least one add-on element, which is configured to connect at least two structural elements of the structural unit to one another.

13. The aircraft device as claimed in claim 3, wherein the constructional unit has at least one functional unit that is at least partially embedded in the structural unit.

14. The aircraft device as claimed in claim 13, wherein the functional unit has at least one supporting element, which is configured for supporting the structural unit.

15. The aircraft device as claimed in claim 13, wherein the functional unit has at least one hinge element, which is configured to connect at least two structural elements of the structural unit movably to one another.

16. An aircraft seat with at least one aircraft device as claimed claim 1.

17. A method for coupling a load-bearing constructional unit of an aircraft device as claimed in claim 1 to at least one further object, wherein the load-bearing constructional unit is coupled to the at least one further object in at least one method step by means of an injection-molding and/or compression-molding process.
